(19) United States
(12) Patent Application Publication
(10) Pub. No.: US 2009/0085726 A1
(43) Pub. Date: Apr. 2, 2009

(54) Power Line Communications Coupling Device and Method

(76) Inventor: William O. Radtke, Ellicott City, MD (US)

Correspondence Address: CAPITAL LEGAL GROUP, LLC, 1100 River Bay Road, Annapolis, MD, 21409, US

(21) Appl. No.: 11/862,353

(22) Filed: Sep. 27, 2007

(51) Int. Cl. G08B 1/08

(52) U.S. Cl. 340/310.17

(57) ABSTRACT

A method and device for providing communications via one or more underground power lines is provided. Underground power lines may comprise a plurality of segments disposed in series with each other and carrying a power having a voltage greater than one thousand volts on an internal conductor, and wherein each segment is coaxial in structure and includes a neutral conductor. In one embodiment, the device may comprise a first inductor having a first end connected to a first node and a second end connected to ground, a second inductor having a first end connected a second node and a second end connected to ground, and a transformer having a first winding having a first end and a second end. The first node may be connected to a neutral conductor of a first segment of the power line and to the first end of the first winding of said transformer. The second node may be connected to a neutral conductor of a second segment of the power line and to the second end of the first winding of said transformer. The transformer comprises a second winding configured to be communicatively coupled to a communication device.

### FIELD OF THE INVENTION

The present invention generally relates to power line coupling devices and methods, and more particularly to a device and method for coupling a broadband power line communication device to an insulated medium voltage power line, such as an underground residential distribution power line.

### BACKGROUND OF THE INVENTION

The need for reliable broadband communication networks to deliver data services such as voice over internet protocol (VoIP), video, internet web data, email, file sharing, stereo over IP, and other such services is increasing. In response to these demands, the communication infrastructure is expanding to include many types of communication networks beyond the public switched telephone network. A power line communication system (PLCS) is an example of a communication network in the expanding communication infrastructure.

A PLCS uses portions of the power system infrastructure to create a communication network. In addition to carrying power signals, existing power lines that run to and through many homes, buildings and offices, may carry data signals. These data signals are communicated on and off the power lines at various points, such as, for example, in or near homes, offices, Internet service providers, and the like.

There are many challenges to overcome when using power lines for data communication. For example, there are many transformers located in the power distribution system. A transformer passes the low frequency signals (e.g., the 50 or 60 Hz power signals) but impedes impeding the high frequency signals (e.g., frequencies typically used for data communication). As such, many power line communication systems face the challenge of communicating the data signals around, or through, the distribution transformers.

Another challenge is that power lines are not designed to provide high speed data communications, and are susceptible to interference and signal losses. For example, some commercial and residential developments are serviced by portions of the power distribution system that are underground. An underground residential distribution (URD) medium voltage (MV) power line typically couples to an overhead power line at a riser pole. URD power lines extend underground from distribution transformer to distribution transformer to deliver power to customer premises. It has been found that the URD MV power line cables are very lossy at frequencies used to provide broadband communications. Further the power levels of signals used to convey data signals along the power lines are regulated by the government. Consequently, in comparison to other communications mediums, the transmitted signals may travel only a relatively short distance over the URD MV power lines.

Accordingly, there is a need for improving the effectiveness of power line communications in a PLCS, and in particular for underground sections of a PLCS. Embodiments of the present invention address this and other needs, and offer advantages for power line communication systems.

### SUMMARY OF THE INVENTION

The present invention provides a method and device for providing communications via one or more underground power lines. Underground power lines may comprise a plurality of segments disposed in series with each other and carrying a power having a voltage greater than one thousand volts on an internal conductor, and wherein each segment is coaxial in structure and includes a neutral conductor. In one embodiment, the device may comprise a first inductor having a first end connected to a first node and a second end connected to ground, a second inductor having a first end connected a second node and a second end connected to ground, and a transformer having a first winding having a first end and a second end. The first node may be connected to a neutral conductor of a first segment of the power line and to the first end of the first winding of said transformer. The second node may be connected to a neutral conductor of a second segment of the power line and to the second end of the first winding of said transformer. The transformer comprises a second winding configured to be communicatively coupled to a communication device.

The invention will be better understood by reference to the following detailed description taken in conjunction with the accompanying drawings.

### BRIEF DESCRIPTION OF THE DRAWINGS

The invention is further described in the detailed description that follows, by reference to the noted drawings by way of non-limiting illustrative embodiments of the invention, in which like reference numerals represent similar parts throughout the drawings. As should be understood, however, the invention is not limited to the precise arrangements and instrumentalities shown. In the drawings:

FIGS. 1a and 1b depict an example underground residential distribution (URD) cable;

FIG. 2 is a block diagram of a section of a power line communication system, in which respective power line communication devices are coupled to power line segments;

FIG. 3 is a schematic diagram of an example embodiment of the present invention coupling a power line communication device to an URD power line cable;

FIG. 4 is a schematic diagram of another example embodiment of the present invention coupling a power line communication device to an URD power line cable;

FIG. 5 is a block diagram of a section of a power line communication system having a URD power line end point, in which power line communication devices are coupled to power line segments;

FIG. 6 is a block diagram of a section of a power line communication system having a parked URD power line segment, in which power line communication devices are coupled to the power line segments;

FIG. 7 is a block diagram of a section of a power line communication system having a branch topology, in which a power line communication device is coupled to multiple URD power line segments at a distribution transformer;

FIG. 8 is a block diagram of a section of a power line communication system having unjacketed URD power line cables at respective distribution transformers, in which respective power line communication devices are coupled to the power line segments;

FIG. 9 is a block diagram of another embodiment of a bypass device with a coupler disposed within the bypass device enclosure according to an example embodiment of the present invention;

FIG. 10 is an illustration of an example embodiment of a power line communication system;

FIG. 11 is an illustration of another example embodiment of a power line communication system according to the present invention;

FIG. 12 is a block diagram of an embodiment of a backhaul device;

FIG. 13 is a block diagram of an embodiment of an MV interface for an example the backhaul device;

FIG. 14 is a block diagram of an example embodiment of a bypass device;

FIG. 15 is a block diagram of an embodiment of a MV interface for an example bypass device;

FIG. 16 is a block diagram of an embodiment of an LV interface for another example bypass device; and

FIG. 17 is an example diagram illustrating a portion of a coupling device according to an example embodiment of the present invention.

### DETAILED DESCRIPTION OF ILLUSTRATIVE EMBODIMENTS

In the following description, for purposes of explanation and not limitation, specific details are set forth, such as particular networks, communication systems, computers, terminals, devices, components, techniques, PLCS, data and network protocols, software products and systems, enterprise applications, operating systems, development interfaces, hardware, etc. in order to provide a thorough understanding of the present invention.

However, it will be apparent to one skilled in the art that the present invention may be practiced in other embodiments that depart from these specific details. Detailed descriptions of well-known networks, communication systems, PLCS, computers, terminals, devices, components, techniques, data and network protocols, software products and systems, operating systems, development interfaces, and hardware are omitted so as not to obscure the description of the present invention.

### Communications Coupling Device and Power Line Cable

According to embodiments of the invention, communication signals may propagate along power lines between power line communication devices (PLCD). For example, communications may be sent downstream from the internet to a power line communication system (PLCS), and from the PLCS back to the internet. User devices, such as computers may be coupled to the PLCS, such as through a power line modem. Accordingly, users may access the internet over the power lines. For example, broadband access to the internet may be achieved using a power line communication system. A user may access the internet, send email and upload content from their computer, and also receive email and download content.

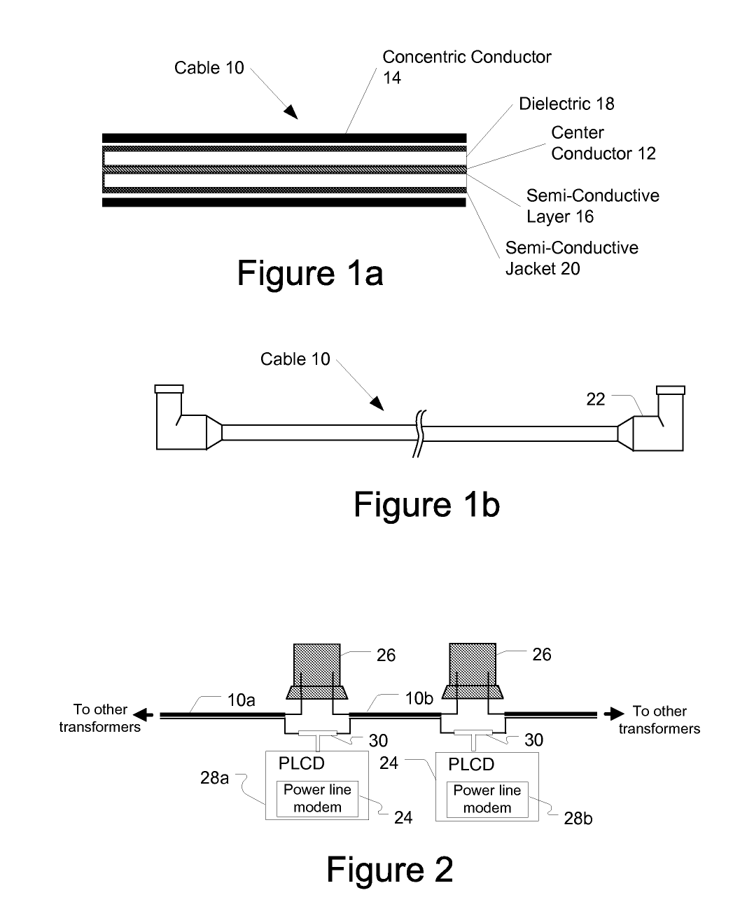

The PLCS may use portions of the power distribution system, including overhead power lines and underground power lines, to carry communication signals. Many underground residential distribution (URD) MV cables have a coaxial structure. As shown in FIG. 1a, an example URD MV cable 10 includes a center conductor 12 that carries the power signal. Surrounding the center conductor 12 is a semi-conductive layer 16. In this example cable, the semi-conductive layer 16 is surrounded by a dielectric 18 (i.e., an insulator). A semi-conductive jacket 20 surrounds the dielectric 18. The semi-conductive jacket 20 typically ensures, among other things, that ground potential and deadfront safety (the grounding of surfaces to which a utility company's lineman may be exposed) are maintained on the surface of the cable. Finally, a concentric conductor 14, which may act as the neutral conductor for power signal transmissions, may surround the semi-conductive jacket 20. Thus, the center conductor 12 is separated from the concentric conductor 14 by dielectric 18 and semiconductor 20 (which acts as a dielectric at frequencies substantially above 50/60 Hz), thereby forming a coaxial structure. At high frequencies, such as those above one megahertz, this structure may act as a transmission line with properties of, or similar to, a wave guide. In some embodiments, this structure has the characteristics of a conventional coaxial transmission cable.

As shown in FIG. 1b, the cable 10 may terminate with an elbow 22 at one or both ends. For example, if the cable 10 is to be plugged into a bushing at a transformer, the cable typically will terminate with an elbow. In other instances, the underground cable will extend up a utility pole and terminate with a “pothead” connector (not shown) for connection to an overhead MV power line (known as a Riser-Pole).

The coupler may be designed for coupling data signals to and from a URD power line cable comprising a center conductor, insulator, and concentric conductor, and may also have other elements such as an external insulator. The URD power line cable 10 described for the use with the present example embodiment comprises those elements shown in FIG. 1a. However, as will be evident to those skilled in the art, the present invention is not limited to cables having all of those elements and may work equally as well with cables having fewer or more elements.

A challenge to transmitting communication signals via URD MV power line cables 10 is that the URD power line cables are very lossy at the frequencies used to provide broadband communications. Further, the ability to overcome signal losses by boosting signal power is limited. Specifically, the government limits the power levels that may be used to transmit signals over the power lines. Consequently, in comparison to other communications mediums, the transmitted signals typically may travel only a relatively short distance on the URD MV power lines 10. According to embodiments of this invention, a differential signaling method may be used to better tolerate interference and signal losses. A coupling device of the present invention serves to implement a differential signaling method.

FIG. 2 shows a portion of a PLCS in which a power line communication device 28 is coupled to a power line cable 10 via a coupling device 30. The power line communication device 28 may include a power line modem 24. The coupling device 30 couples the PLCD 28 to the power line 10 at a distribution transformer 26. Such a configuration may be implemented at each distribution transformer 26 along a portion of a power line communication system (PLCS).

In an example embodiment, a differential signaling method is used to transmit information along segments of the URD cable 10. The differential signaling method uses the difference in voltage between two wires (e.g., the center conductor 12 and neutral conductor 14 of a URD cable 10) to convey information. Using such signaling method, the signals may have a lower susceptibility to noise. Specifically, distant radiated noise sources tend to add the same amount of noise (called common-mode noise) to both wires, causing the voltage difference between the neutral and center conductor to remain the same. To transmit differential signals, equal but opposite RF currents (and voltages) from the PLCD 28 are transmitted onto the neutral conductor 14 of each of the two URD cable segments 10a, 10b connected to the coupling device 30. Due to the characteristic impedance of the URD power line cable segments 10a,b, equal but opposite currents, in turn, are induced on the center conductors 12 of the two cable segments 10a, 10b. Thus, the center conductor 12 and neutral conductor 14 of a given URD power line cable segment 10 carry the power line communication signal differentially. The signals, however, are applied differentially to the neutral conductors of the two segments.

Thus, the differential signaling method reduces the effect of noise on the URD power line cable segments 10 by rejecting common-mode interference. In particular, the center conductor 12 and neutral conductor 14 extend in parallel and receive the same interference. The center conductor 12 carries the power line communication signal, and the neutral conductor carries the inverse of the power line communication signal, so that the voltage differential between the two conductors remains generally constant.

A power line communication signal is sent differentially from one power line communication device (PLCD) 28a along a URD power line cable segment 10 to another PLCD 28b. At the PLCD 28 receiving the communication, the difference between the signals on the center conductor 12 and neutral conductor 14 of URD power line cable 10 is detected. Because the PLCD 28 ignores each conductor's voltages with respect to ground, small changes in ground potential (and both conductor's potential) from the transmitting PLCD 28 and receiving PLCD 28 generally do not affect the receiver's ability to reliably receive the signal.

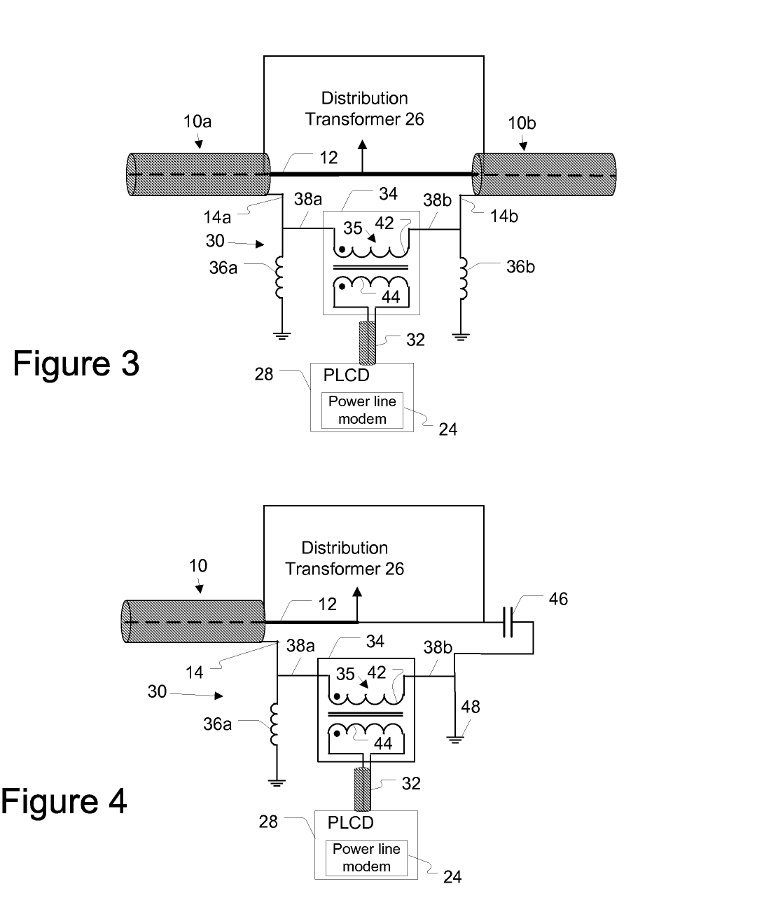

FIG. 3 shows a coupling device 30 which may be used to achieve differential signaling along a medium voltage (MV) power line, such as a URD power line 10. In the vicinity of a distribution transformer 26, the coupling device 30 couples a PLCD 28 (e.g., a bypass device 28) to a neutral conductor 14a of an upstream URD power line cable segment 10a and to a neutral conductor 14b of a downstream URD power line cable segment 10b. As described above, the signals in turn are induced onto the center conductor 12 due to the characteristic impedance of the URD power line 10. The communication signals travel in each direction away from the distribution transformer 26. As is known to those skilled in the art, the center conductors 12 of the URD power line segments 10a, 10b are jointly coupled to a first end of a primary winding (not shown) of the distribution transformer 26. The other end of the distribution transformer's primary winding typically is connected to ground, such as through a transformer bushing (not shown). The secondary winding of the distribution transformer 26 provides low voltage power to one or more customer premises.

In the example embodiment of FIG. 3, two URD power line cable segments 10a, 10b are connected to a distribution transformer 26. The coupling device 30 couples a power line communication signal to and/or from each of the upstream URD power line cable segment 10a and downstream URD power line cable segment 10b. The coupling device 30 includes a pair of inductors 36, a pair of conductors 38, and a transformer 34, such as a balun 35 having a first winding 42 and a second winding 44. A cable 32 having two conductors may extend from the BD 24 to the coupler 34, such as to the respective ends of the balun's second winding 44.

Typically, at the distribution transformer 26 the neutral conductors 14a,b also are connected to ground. In the example embodiment, the coupling device 30 includes a pair of inductors 36 form an impedance to high frequency signals (e.g., greater than one megahertz in some embodiments and greater than ten megahertz in other embodiments) between the injection point and ground. In various embodiments the inductors 36 may be air core coils inserted in series, or toroid-shaped ferrites disposed around a conductor connecting the neutral conductors 14a,b to ground. In yet another embodiment, the inductors 36 may comprise a rod core having the conductor wound around the rod core. The high frequency impedance of the inductors 36 allows a signal to propagate from a conductor 38 of the coupling device 30 over the neutral conductor 14, instead of being conducted to ground. The high frequency impedance may comprise a high pass filter in some embodiments. During installation, the neutral conductors 14 may be disconnected from ground, and connected to ground via the inductors 36.

In an example embodiment, one inductor 36a may be coupled at one end to the neutral conductor 14a of one URD cable segment 10a, and at the other end to ground. Similarly, the other inductor 36b may be coupled at one end to the neutral conductor 14b of another URD cable segment 10b, and at the other end to ground. One end of winding 42 may be coupled to an end of a corresponding inductor 36a (via conductor 38a) which couples to the neutral conductor 14a of URD cable 10a. Similarly, the other end of winding 42 may be coupled to an end of a corresponding other inductor 36b (via conductor 38b) which couples to the neutral conductor 14b of URD cable 10b.

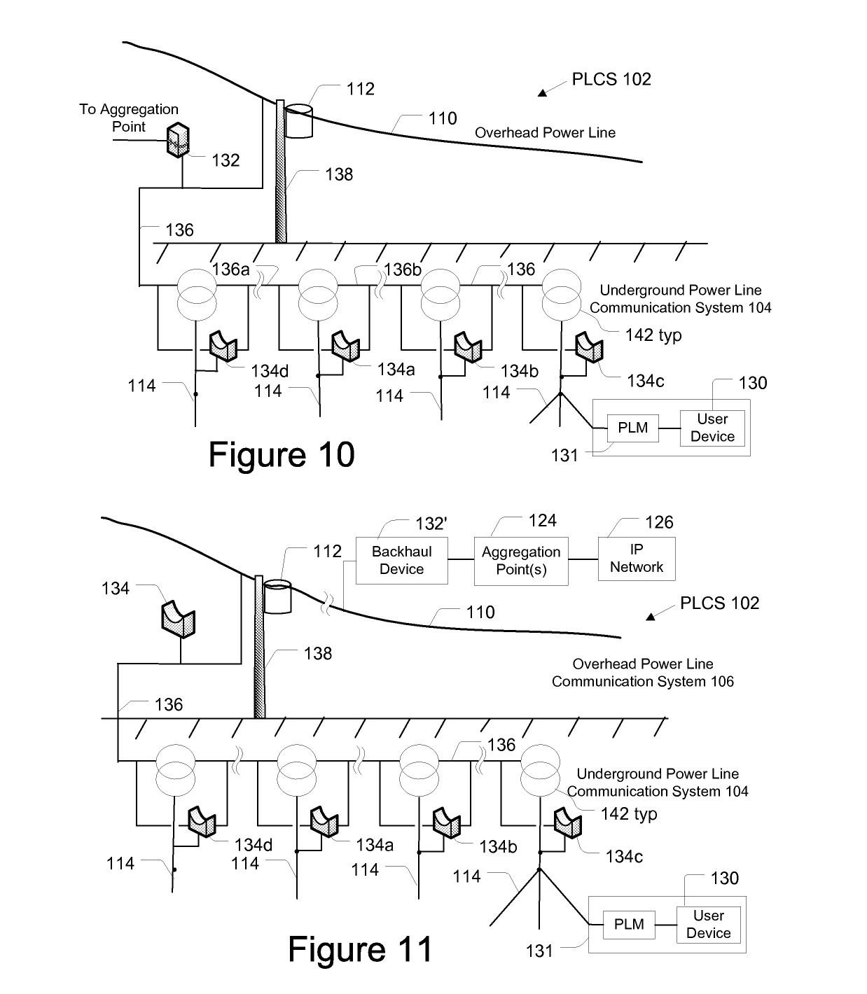

The PLCD 28 may receive a power line communication propagating along either of the URD power line cable segments 10a, 10b. The communication signal is received differentially via the balun's first winding 42, induced onto the second winding 44, and then received by the PLCD 28. The PLCD 28 also may receive communication signals propagating along a low voltage power line (not shown) received from one or more user devices 130 (see FIG. 10). The PLCD 28, in turn, may retransmit received data onto the URD power line segments 10a, 10b (or onto an LV power line 114 for transmission to a user device at premises 135). With regard to the URD power line communications, the PLCD 28 may transmit the communication via a cable 32 to the coupling device 30. The communication is received at the second winding 44 of balun 35 and induced onto the first winding 42. The communication signal then propagates onto the neutral conductors 14 of each of the URD power line segments 10a, 10b. Due to the impedance of the URD power line cable 10, an equal and opposite signal is induced onto the URD power line cables' center conductors 12. The communication signal then propagates along the URD power line cable segments 10a, 10b to the next PLCD 28 in each direction. At the next PLCD 28, the PLCD 28 differentially detects the communication signal and, in turn, may retransmit the data.

The impedances of the inductors 36 and the center conductors 12, along with the impedances of the elbow 22 (see FIG. 1), the transformer 26, a feed-through bushing connecting the center conductors 12 of URD power line cable segments 10a, 10b (not shown), and inductances of the neutral conductors 14, cause insertion losses for communication signals at the high and low ends of a 2-50 MHz band. A typical value of such insertion loss of some embodiments is less than 4 db, and nominally 3 dB.

The power line distribution system may include termination points, where an MV power line ends. For example, a URD power line segment 10 may extend to a distribution transformer 26, and end at that transformer with no additional MV power line segment extending onward. FIG. 4 shows a configuration in which the coupling device 30 couples the PLCD 28 communications to and from the URD power line cable at such a termination point. The coupling device 30 may be similar to the coupling device 30 of FIG. 3, while omitting one of the inductors 36b. The URD power line cable 10 center conductor 12 extends to one end of a primary winding of the distribution transformer 26. That end of the primary winding also may be connected to a surge arrestor 46 (e.g., lightening arrestor) coupled to ground (through a transformer bushing not shown), which acts as a capacitor and is coupled to ground 48. The coupling device 30 is coupled to the URD power line cable 10 in a same manner as the coupling device 30 is coupled to the URD power line cable segment 10a of FIG. 3. Specifically, inductor 36a may be coupled at one end to the neutral conductor 14 of one URD cable segment 10a, and at the other end to ground 48. One end of winding 42 of the balun 34 may be coupled to an end of the inductor 36a (via conductor 38a) which couples to the neutral conductor 14 of URD cable 10. The other conductor 38b couples the other end of the winding 42 to ground 48 in parallel with the surge arrestor 46. As a result, communications from the PLCD 28 are transmitted differentially between the neutral conductor 14 and the center conductor 12 of the URD power line cable 10.

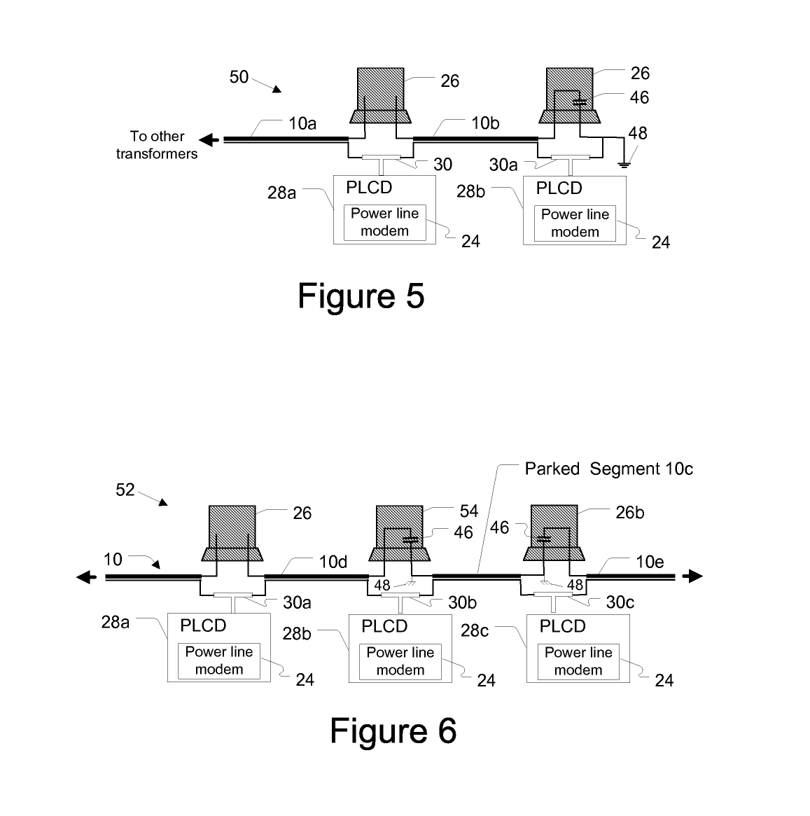

FIG. 5 shows a coupling configuration for a portion 50 of a PLCS, at a termination point along a URD power line cable 10. Communications are transmitted along segments of the URD power line cable 10. At each transformer 26, the communication may be coupled to the PLCD 28 by a coupling device 30. At the end of the URD power line cable 10, the communication is coupled to and from a PLCD 28b via a single-sided coupling device 30a. Communications also may be transmitted from the PLCD 28b at the end of the URD power line cable 10 upstream toward other transformers 26 and PLCD 28a.

FIG. 6 shows a coupling configuration for a portion 52 of a PLCS having a parked URD power line cable segment 10c. A parked cable is de-energized and grounded at a mid-loop transformer 54. It may be desirable to not communicate data signals over parked cables. In an example coupling embodiment, coupling around parked cables may be handled in a similar manner as coupling to a cable at a termination point. By treating transformers 54 and 26b as termination points, each end of the parked cable segment 10c functions like a termination point of an MV power line. A single-sided coupling device 30b couples communications from a PLCD 28b onto a URD power line cable segment 10d at transformer 54. Another single-sided coupling device 30c couples communications from a PLCD 28c onto a URD power line cable segment 10e at transformer 26b. Thus, communications do not propagate onto the parked URD power line cable segment 10c.

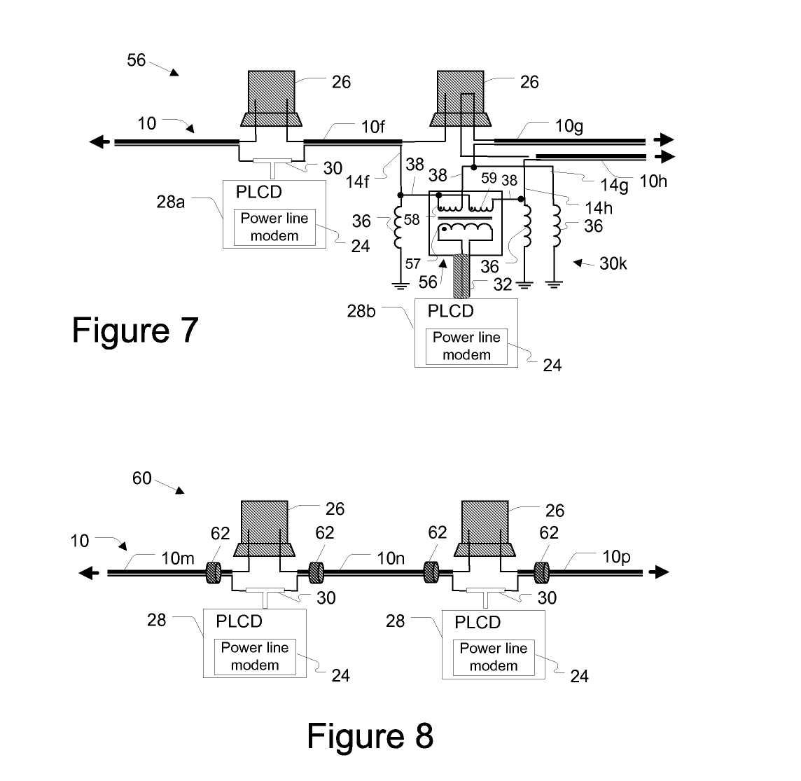

FIG. 7 shows a coupling configuration for a portion 56 of a PLCS having a branched topology. As power is distributed from a power station along MV power lines, there may be locations where the power lines branch to supply power to different regions or neighborhoods. For example, URD power line cable segment 10f may be an “incoming power line” supplying power to transformer 26b. The outgoing power may be branched and include two URD power line cable segments 10g, 10h. The center conductors of such URD power line cable segments 10f, 10g, 10h may be coupled together and also to the primary winding of the transformer, (the other end of the primary winding may be coupled to ground). A PLCD 28 may be coupled to the respective neutral conductors of all three URD segments 10f, 10g, 10h by a coupling device 30k. Such coupling device 30k may be similar to the coupling device 30 discussed above, but including a three-way balun 56 rather than the two-way balun 35 shown in FIG. 3. Accordingly, there may be three inductors 36 and three conductors 38 in the coupling device 33. One end of each conductor 38 may be coupled to a winding 58, 59 of the balun 56. An opposite end of each conductor 38, respectively, may be coupled to an inductor 36 and to a neutral conductor 14 of the corresponding URD power line cable segment 10f, 10g, 10h, in the same manner as the conductors 38 and inductors 36 of FIG. 3. Also, each inductor 36 may be coupled to ground, as in the coupling device 30 of the embodiment of FIG. 3. Each of two conductors of a data cable 32 may extend from the PLCD 28 to opposite ends of a third winding 57 of the balun 56 to couple the PLCD 28 to coupling device 30k.

Communications transmitted along the URD power line cable segment 10f may be received at the PLCD 28b, and may be retransmitted onto the URD power line cable segments 10g, 10h using the differential signaling method described above. Similarly, communications transmitted along the URD power line cable segment 10g are received at the PLCD 28b, and may be retransmitted onto the URD power line cable segments 10f, 10h. Communications transmitted along the URD power line cable segment 10h are received at the PLCD 28b, and may be retransmitted onto the URD power line cable segments 10f, 10g.

FIG. 8 shows a coupling configuration for a portion 60 of a PLCS having URD power line cables that are unjacketed (do not have an external insulator or covering) at the distribution transformer 26. Because the neutral conductors are unjacketed, the neutral conductors of adjacent URD power line cable segments 10m, 10n or 10n, 10p may come into contact with each other and potentially “short out” communications to and from the coupling device 30. Accordingly, in some embodiments a common-mode choke 62 (e.g., toroid-shaped magnetically permeable material such as ferrites) is disposed around each cable segment 10 near a transformer 26. Even in the event that the neutral conductors become shorted, the presence of the common-mode choke 62 allows communication signals to be coupled to the PLCD 28 through the coupling device 30 (by impeding common mode signals and allowing differential signals to pass substantially unimpeded). Thus, this use of common modes chokes may be an optional addition to the embodiment of FIG. 3.

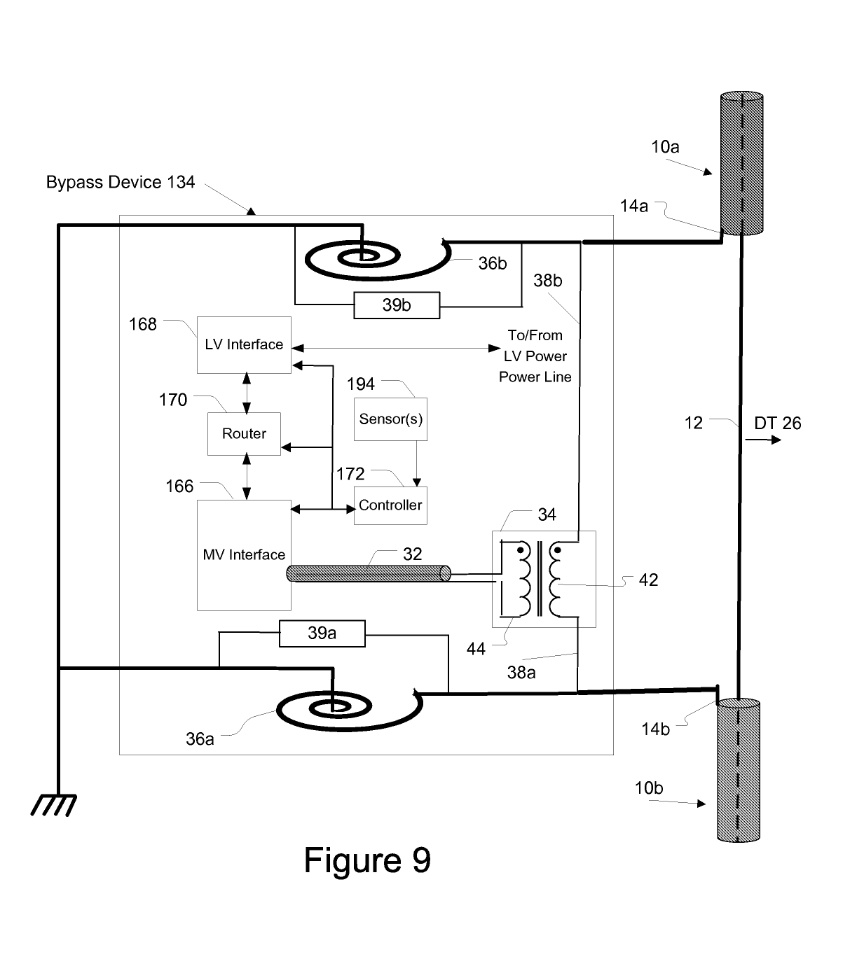

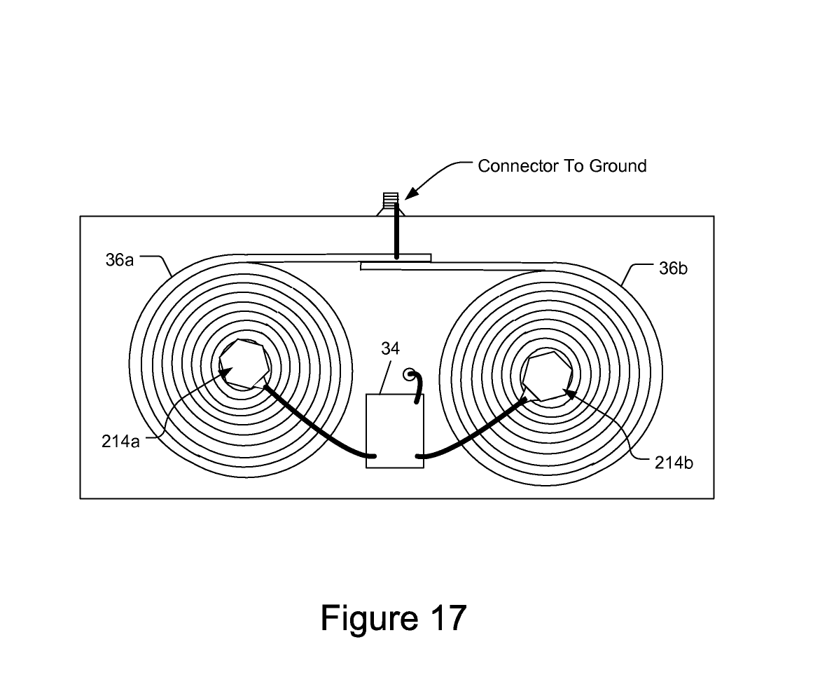

FIG. 9 illustrates an example implementation of a coupling device that is disposed inside the housing of the bypass device 134. Specifically, the transformer 34 (a balun in this example) and the inductors 36a and 36b are mounted inside the housing of the bypass device 134 and connected to the neutral conductors 14a,b of the MV power line 12. This example embodiment also includes a voltage clamping device 39a,b in parallel with each inductor 36a, 36b to ensure a path to ground for electric energy that results from a lightening strike to the power line. The voltage clamping device 36 may comprise a low voltage gas discharge tube, thyristor, voltage controlled switch, saturatable reactor (e.g., an inductor that saturates quickly), or other suitable device. In this example embodiment, the voltage clamping device 36 is configured to normally be an open circuit and then provide a short (for frequencies including those associated with a lightening pulse) when the voltage across the device 39 reaches ninety voltages. FIG. 17 provides an example implementation of a portion of the coupling device according to one or more example embodiments. The inductors 36a and 36b comprise a copper conductor having a rectangular cross-section that is wound into a coil having multiple loops with each loop being separated from the adjacent loop by a dielectric. The center 214a,b of each inductor 36a,b is connected to the transformer 34 while the other ends of the inductors 36 are connected together and also connected to a connector that connects to ground.

### Power Line Communication System

FIGS. 10 and 11 show example embodiments of a portion of a power line communication system (PLCS) 102 in which the coupling device 30 described above may be used. The PLCS 102 includes a plurality of power line communication devices 132, 134 which couple to power lines 136 of the power system infrastructure. In various configurations the power line communication system may include one or more power line communication networks, such as an underground power line communication network 104 and/or an overhead power line communication network 106. The power line communication system 102 may include MV power lines 110, LV power lines 114, neutral conductors and various power line communication devices 132, 134. In various embodiments the MV power lines may include underground MV URD power lines 136 and/or overhead MV lines 110. Data may be transmitted and received between power line communication devices (PLCD) over the power lines. Coupling devices 30 according to various embodiments (see FIGS. 3, 4 and 7) of the invention may be used to couple communications between PLCDs 134 (referred to as PLCD 28 above) and the power lines 136 for various configurations, such as shown in FIGS. 2 and 5-9.

In an example embodiment users access the system with user devices 130, such as a computer, LAN, router, Voice-over IP endpoint or ATA, game system, digital cable box, power meter, security system, alarm system (e.g., fire, smoke, carbon dioxide, etc.), stereo system, television, fax machine, HomePlug residential network, or other device having a digital processor and data interface. A power line modem 131 may couple the user device 130 to the power line communication network 102.

FIG. 10 shows an example embodiment where power is delivered to an underground power distribution system 104 by an underground MV power line 136, such as an underground residential distribution cable—‘URD power line cable’). The URD power line cable may be coupled to an overhead power line 110 at a riser pole 138 using conventional power line coupling techniques.

The power line communication system 104 includes the underground power line 136 and power line communication devices (e.g., backhaul device(s) 132, bypass devices 134). Data communications from an IP network may be routed through an aggregation point to a backhaul device 132. The backhaul device 132 may be communicatively coupled to the underground power line 136. In various embodiments, the backhaul device 132 also, or alternatively, may be physically coupled to the overhead power line 110.

As discussed, underground residential power systems typically include distribution transformers 142 located at intervals along the underground power line 136. In this embodiment, a bypass device 134 may be installed at each transformer 142 (e.g. within the transformer enclosure). A bypass device 134a may receive a data signal from a first segment of the underground MV power line 136a and may repeat (re-transmit) the signal onto the adjacent segment of power line 136b to facilitate continued propagation of the communication in the direction of the intended destination. The URD power lines are very lossy at high frequencies used to communicate broadband high speed data signals. Consequently, the repeating system ensures reliable communications.

A bypass device 134 also may have the capability to receive and transmit power line communications over an LV power line 114 which may extend to one or more power system customer premises. For example, bypass device 134d may receive data from backhaul device 132 and transmit the data onto the LV power line 114. The communication protocols, prioritizing and routing functions for the power line communications are further described below in a separate section. As discussed above, one or more LV power lines may feed off of the transformer 142 thereby allowing each 134 to serve one or more customer premises. The frequencies bands used for communication over the LV power lines may be the same or different from those used on the MV power lines. In one example embodiment, communications on the MV power lines are in the 30-50 MHz band and communications on the LV power lines are in the 4-20 MHz band. In one example embodiment, the network is not a pier to pier flat network, but instead, each device may communicate with one (or more) upstream devices.

At the customer premises a power line modem 131 serves as a user device interface to the power line communication system 102. One or more power line modems 131 may be coupled to a given LV power line 114. Further, a user device 130 may be a router or other user device. Thus, a given power line modem 131 may serve one or more user devices 130.

The power line communication system 102 may be monitored and controlled via the power line server 144, which may be remote from the structure and physical location of the PLCS 102 communication devices. In the embodiment illustrated, the power line server 144 may receive data from bypass devices 134 through a backhaul device 132, AP 124, and an IP network 126. Similarly, the power line server 144 may send configuration and other control communications to the bypass devices 134 (and backhaul devices 132) through the IP network 126, backhaul device 132 and a portion 146 (e.g., power lines, intervening power line communication devices) of the PLCS 102. The monitoring and control operations of the power line server 144 are described below in more detail in a separate section.

### Communication Methodology

Upstream communications originating from a user device 130 typically are implemented using a unicasting methodology. A power line modem 131 receives data from a user device 130. The power line modem may package the data and couple a data signal onto an LV power line 114 as a power line communication. Bypass device 134a may receive the communication from the LV power line 114, and in response may package and forward the communication onto the underground MV power line 136. The power line communication propagates along the MV power line 136. The communication may propagate in both directions, (e.g., toward bypass device 134d and bypass device 134b). Each bypass device 134d and 134b may detect a data signal presence on the MV power line 136 and evaluate the packet headers. For a communication destined for the IP network 126, the data packets may include a destination address (e.g., a MAC address) that corresponds to the backhaul device 132 (or AP). If bypass device 134b may detects that the destination address is that of the backhaul device 132 (or AP) and the source address is that of bypass device 134d, bypass device 134a may simply ignore the packet. Thus, bypass device 134b will not re-transmit the power line communication onto the underground MV power line 136. Due to signal losses along the underground power line 136, typically bypass device 134c would not receive the data packet, but if it did it would also ignore the data packet upon evaluation of the addresses. However, in the other direction bypass device 134d also may detect the data signal presence on the underground MV power line 136 and evaluate the data packet header of the communication. The bypass device 134d may determine that the power line communication has an upstream destination address, such as that of bypass device 132 or the AP 124. Thus, bypass device 134d re-transmits the power line communication onto the MV power line 136 (which would be received and ignored by bypass device 134a). In this manner the power line communication which may include the data originating at user device 130, or a downstream bypass device 134, eventually propagates to the backhaul device 132, which may transmit the data packets along another medium to the AP 124 and IP network 126.

Downstream data from IP network 126 may be received at a backhaul device 132. The backhaul device 132 may receive data packets from an IP network 126, and may transmit the data packet(s) to the nearest downstream bypass device 134d. Each bypass device 134 receiving a data packet(s) may evaluate the packet to determine its destination address (e.g., MAC or IP address). By looking up the addresses of user devices on the bypass device 134 LV subnet, the bypass device 134 can determine if a data packet is addressed to a user device on its LV subnet. If the destination address corresponds to a user device on the bypass device's subnet, it will typically transmit the data packet onto the LV power lines for reception by the user device. Alternately, if the data packet is addressed to the bypass device 134 itself, it may process the data packet as a control command. If the data packet is not addressed to the bypass device 134 itself or to a user device on the bypass device's LV subnet and the source address is an upstream device (e.g., another bypass device 134, the backhaul device 132, the AP 124, or other device), the bypass device typically will transmit the data packet onto MV power line 136 for reception by a downstream device.

In an alternate embodiment, the bypass device also may include information in its routing table to determine that the data packet should be re-transmitted onto the MV power line and, therefore, may transmit the data packet onto MV power line 136 only if the destination and source addresses corresponds to such an address in memory. For example, each bypass device 134 may include the MAC address of the adjacent upstream and downstream bypass device. Thus, each bypass device may replace the source address of a data packet with its own MAC address to allow other bypass devices to determine whether to repeat the data.

The decision making at each bypass device 134 is referred to as a routing function, and may be performed by the router (or controller which also serves as the router). The routing function may be evaluated in part by accessing a routing table. For example, a routing table may be stored at the device's router or controller. Addresses of registered user devices and other network elements served by the bypass device 134 may be stored in the routing table. In addition, network elements of the bypass device (e.g., modems, outer, controller) may also have network addresses. In this manner the power line communication eventually propagates to the ultimate destination. The term router, route, and routing are meant to be inclusive of such functions performed by routers, bridges, switches, and other such network elements.

Communication among power line power line communication devices may occur using a variety of protocols. In one embodiment a broadband communication system is implemented in which the communication devices implement one or more layers of the 7 layer open systems interconnection (OSI) model. According to an embodiment, communications may be implemented at layer 2 (data link) and layer 3 (network) of the communication devices within a 7-layer open system interconnection model. At the layer 3 level, the devices and software implement switching and routing technologies, and create logical paths, known as virtual circuits, for transmitting data from node to node. Routing and forwarding are functions of layer 3, as well as addressing, internetworking, error handling, congestion control and packet sequencing. Layer 2 activities include encoding and decoding data packets and handling errors in the physical layer, along with flow control and frame synchronization. The data link layer is divided into two sublayers: the Media Access Control (MAC) layer and the Logical Link Control (LLC) layer. In some embodiments, a power line routing protocol is implemented at level 2 of the 7-layer OSI model.

The communication devices may perform various high level functions. One function is to perform processes responsive to power line server commands. Another function is to prioritize the transmission of power line communications. Accordingly, the bypass device may prioritize transmission onto the MV or LV power lines. For example, based on the type of data, priority tagging of a data packet, or other information, a bypass device may prioritize transmission of data onto the MV power line of data received via an LV power line from a user device and data received via the MV power line from another bypass device 134. In one embodiment, a voice data and/or video data may be accorded a higher priority than other general data (e.g., web page data, email data, etc.). Note that an exemplary bypass device may perform an operation (receive or transmit) an MV power line communication while also performing an operation (receive or transmit) for an LV power line communication.

Wireless communications, such from the backhaul device 132 to its upstream device or between a bypass device 134 and its user devices, when implemented may occur using protocols substantially conforming to the IEEE 802.16 standards, multipoint microwave distribution system (MMDS) standards, IEEE 802.11 standards, DOCSIS (Data Over Cable System Interface Specification) signal standards, or another suitable signal set. The wireless links may use any suitable frequency band. In one example, frequency bands are used that are selected from among ranges of licensed frequency bands (e.g., 6 GHz, 11 GHz, 18 GHz, 23 GHz, 24 GHz, 28 GHz, or 38 GHz band) and unlicensed frequency bands (e.g., 900 MHz, 2.4 GHz, 5.8 Ghz, 24 GHz, 38 GHz, or 60 GHz (i.e., 57-64 GHz)). In another example, frequencies are selected from among other frequency bands including a 75 GHz frequency and a 90 GHz frequency. In still another example, it may desirable to use frequencies that are greater than 2 GHZ, more preferably greater than 5 GHz, still more preferably greater than 22 GHz, and even more preferably greater than 57 GHz.

In some these embodiments power line communications may propagate between the underground power line 136 and overhead power line 110 unless isolation of data signals is provided. Such propagation may be desired or undesired depending on the embodiment. FIG. 11 shows an embodiment in which the backhaul device 132 is coupled to an overhead MV power line 110 away from the riser pole 139. In such an embodiment a bypass device 134 may be coupled to the underground power line the riser pole and repeat the power line communication, so as to propagate the communication onto the overhead power line 110. One skilled in the art will appreciate that the underground power line 136 may extend above ground at the riser pole 139 to couple with the overhead power line 110. The backhaul device 132 (see FIG. 10) or bypass device 134 (see FIG. 11) may couple to the underground power line 136 at a location above ground or underground in the vicinity of the riser pole 139. The backhaul device 132 coupled to the overhead power line 110 may also provide communications to one or more bypass devices 134 that are coupled to the overhead MV power line 110 or other overhead medium.

Thus, in such a configuration the underground and overhead networks may implement compatible communication protocols and be communicatively coupled. In such configurations the underground and overhead networks may share a backhaul 132 (see FIG. 11) for communications with an IP network 126. In other configurations the underground power line network implements a different communication protocol than the overhead power line communication network. In such incompatible configuration, the underground power line communication signals are generally filtered and/or isolated from the overhead power line communication signals, so that interference between the two types of communication signals is minimized or avoided.

### Power Line Communication Devices

Exemplary power line communication devices 28 include a backhaul device 132, and a bypass device 134.

### Backhaul Device 132:

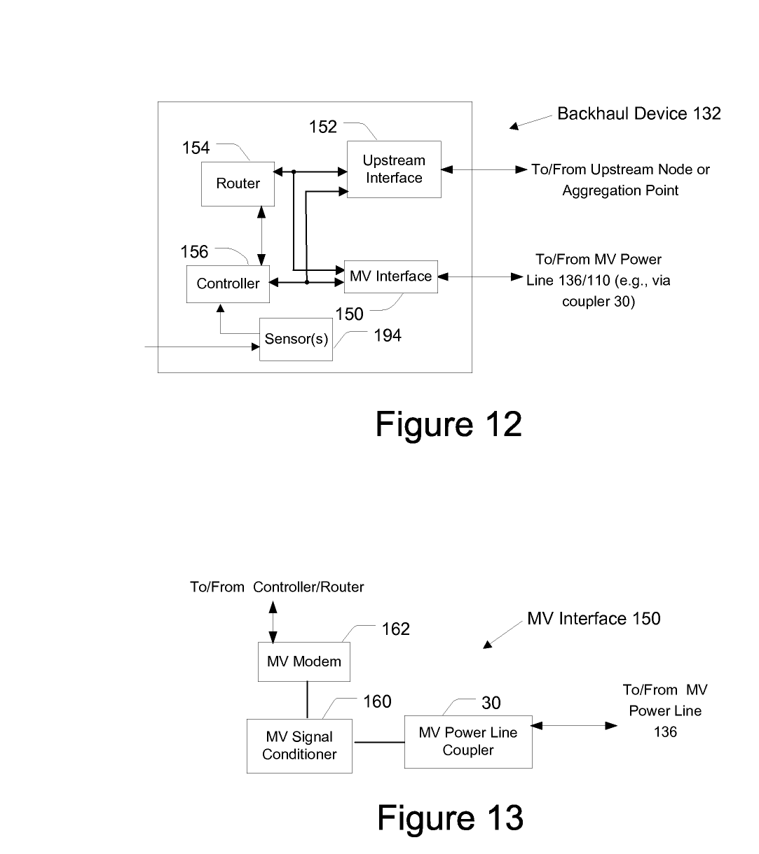

FIG. 12 shows a backhaul device 132. A backhaul device 132 is a communication device to which many other power line communication devices may route data to be forwarded out of the power line communication system 102. The backhaul device 132 may route the data directly to an aggregation point 124 or to an upstream node(s) 127, which in turn may route the data to an aggregation point 124. A backhaul device 132 may be coupled to an MV power line and to a backhaul link (e.g., fiber optic, twisted pair, coaxial cable, T-carrier, Synchronous Optical Network (SONET), or another wired or wireless media) serving to link to an upstream node 127 or aggregation point 124.

The backhaul device 132 may include an MV interface 150, an upstream interface 152, a router 154 and a controller 156. In some embodiments the router may form part of the controller 156. Referring to FIG. 13, the MV interface 150 may include a MV power line coupler 30, a MV signal conditioner 160 and a MV modem 162. The MV power line coupler 30 (described above) couples data to/from the MV power line and prevents the medium voltage power from passing from the MV power line 136 to the rest of the backhaul device's circuits, while allowing the communications signal to pass to/from the backhaul device 132 from/to the MV power line 110/136. The MV signal conditioner 160 may include a filter (for filtering for frequency band(s) of interest), amplifier and other circuits which providing transient voltage protection. Data signals from the MV signal conditioner 160 are supplied to the MV modem 162, which demodulates/modulates the signals.

In various embodiments the upstream interface 152 may include a fiber optic modem, wireless modem, or another suitable transceiver for communication over a medium that couples the backhaul device with 132 an upstream node 127 or aggregation point 124.

The backhaul device router 154 routes data along an appropriate path. The router 154 may receive and send data packets, match data packets with specific messages and destinations, perform traffic control functions, performs usage tracking functions, authorizing functions, throughput control functions and similar routing-relating services. The router 154 may route data from the MV interface 150 to the upstream interface 152 and from the upstream interface 152 to the MV interface 150. Thus, the router 154 may serve to route data (i) from the MV power lines to an upstream node 127 or aggregation point 124, and (ii) from the upstream node 127 or aggregation point 124 to the MV power lines 136/110.

The backhaul device 132 may also include a processor or other controller 156 which controls operations of the backhaul device 132, such as the receiving software downloads, responding to commands from the PLS, etc. Additional description of the controller 156 is described below in a separate section.

The backhaul device 132 also may have a debug port to connect serially to a portable computer. The debug port preferably connects to any computer that provides terminal emulation to print debug information at different verbosity levels and can be used to control the power line communication device in many respects such as sending commands to extract all statistical, fault, and trend data. Further, in some embodiments one or more sensors 194 are included at or in the vicinity of a backhaul device 132. The sensors are described in more detail below in a separate section. In another embodiment, the backhaul device 132 may include a low voltage interface to service user devices (discussed below).

### Bypass Device 134:

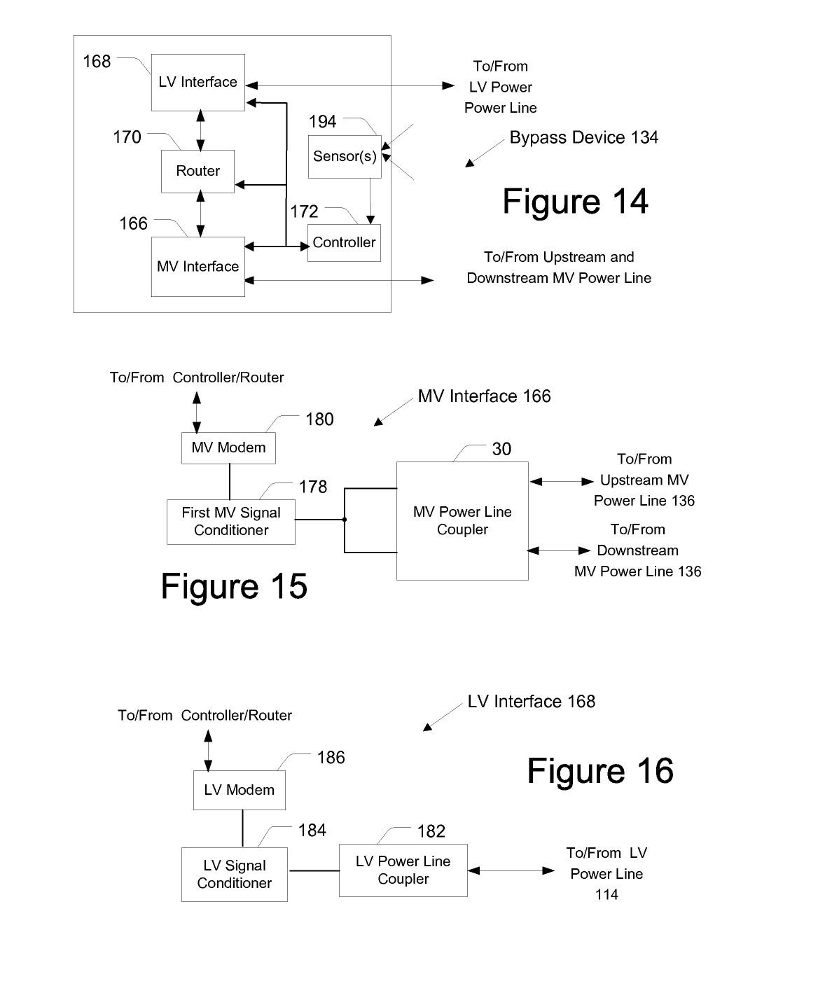

FIG. 14 depicts an example embodiment of a bypass device 134 for communicating with an underground power line 136. The bypass device 134 may include an MV interface 166, an LV interface 168, a router 170 and a controller 172. FIG. 15 the MV interface 166, which may be used to couple to the two MV power lines 136—one power line 136a at an upstream side of a transformer 142 and the other 136b on a downstream side of the transformer 142 (see FIG. 10). The MV interface 166 may include an MV power line coupler 30 (such as described above) that couples to the power line segments on the upstream side of the transformer 142 and the downstream side of the transformer 142, an MV signal conditioner 178 and an MV modem 180. These components function substantially the same way as the similar named components of MV interface of the backhaul device 132 and therefore their description is not repeated here. In an alternate embodiment, only one MV power line coupler is used (e.g., on the upstream side of the transformer) and the data signals may be repeated via that coupler or, alternately, may not be repeated and simply allowed to propagate further downstream for reception by other bypass devices 134.

FIG. 16 depicts an LV interface 168, which may couple to the LV power line 114. The LV interface 168 may include an LV power line coupler 182, an LV signal conditioner 184 and an LV modem 186. In one embodiment the LV power line coupler 182 may be an inductive coupler and, in yet another embodiment, may be a capacitive coupler. In another embodiment the LV power line coupler 182 may be a galvanic coupler (e.g., mechanical clamp). The LV signal conditioner 184 may provide a filter (for filtering for the band of interest), amplifier, and other circuits which providing transient voltage protection Data signals from the LV signal conditioner 184 are supplied to the LV modem 186, which demodulates/modulates the signals.

The bypass device 134 may also include a router 170 and controller 172. The router 170 may receive and transmit data packets, match data packets with specific messages and destinations, perform traffic control functions, and perform usage tracking functions, authorizing functions, throughput control functions and similar routing-relating services. The router 170 may route data from the LV interface 168 to the MV interface 166, from the MV interface 166 to the LV interface 168, and from the MV interface 166 back through the MV interface 166. Thus, the router 170 may route data (i) from the MV power lines 136 to the LV power lines 114 to a customer's premises, and (ii) from the LV power lines 114 to the MV power line 136. The router may also repeat data signals received from the MV power line 136 back onto the MV power line 136 so as to further propagate the data signal along the URD power line cable.

In some embodiments user devices and varying types of data packets are assigned a priority level. In such embodiments the bypass device 134 may assess the priority of a power line communication to be transmitted onto the LV power line 114 or received from the LV power line 114. For example, it is beneficial to allow a higher priority for voice over internet (voice data) data packets, than for simple textual e-mail transmission data packets. Priority levels may be assigned by the network element manager, power line server 144 or local controller 156/172, bypass device 134, and may be enforced at the controller 156/172 (or router).

Various embodiments of bypass devices 134 may provide various communication services for user devices 130 such as for example: security management; IP network protocol (IP) packet routing; data filtering; access control; service level monitoring; service level management; signal processing; and modulation/demodulation of signals transmitted over the communication medium.

Further, in some embodiments one or more sensors 194 are included at or in the vicinity of a bypass device 134. The sensors 194 are described in more detail below in a separate section.

### Controller 156/172:

As described above, the power line communication devices, such as a backhaul device 132 or bypass device 134, may include a controller 156/172. The controllers 156, 172 include hardware and software for managing communications and control of the power line communication device 132, 134 at which the controller is located. In one embodiment, the controller 156/172 may include an IDT 32334 RISC microprocessor for running embedded application software, along with flash memory for storing boot code, device data, configuration information (serial number, MAC addresses, subnet mask, and other information), application software, routing table(s), and statistical and measured data. In some embodiments the memory may also store the program code for operating the processor to perform the routing functions in place of a router.

The controller 156/172 also may include random access memory (RAM) for running the application software and for providing temporary storage of data and data packets. The controller 156/172 may also include an Analog-to-Digital Converter (ADC) for taking various measurements, which may include: (i) measuring the temperature inside a bypass device 134 enclosure or other device enclosure (through a temperature sensor such as a varistor or thermistor), (ii) taking power quality measurements, (iii) detecting power outages and power restoration, (iv) measuring the outputs of feedback devices, and (v) other measurements. The controller 156/172 may also include a “watchdog” timer for resetting the communication device should a hardware glitch or software problem prevent proper operation to continue.

In addition to storing a real-time operating system, the memory of controller 156/172 also may include various program code sections such as a software upgrade handler, software upgrade processing software, power line server (‘PLS’) command processing software (which receives commands from the PLS 144, and processes the commands, and may return a status back to the PLS 144), ADC control software, power quality monitoring software, error detection and alarm processing software, data filtering software, traffic monitoring software, network element provisioning software, and a dynamic host configuration protocol (DHCP) Server for auto-provisioning user devices (e.g., user computers) and associated power line communication devices.

The backhaul device 132 controller 156 may also include an Ethernet adapter with an optional on-board MAC and physical (PHY) layer Ethernet chipset that can be used for converting peripheral component interconnect (PCI) to Ethernet signals for communicating with an upstream interface 152 (see FIG. 13). For example, an RJ45 connector may provide a port for a wireless transceiver for communicating wirelessly.

The power line communication devices (e.g., backhaul device 132, bypass devices 134, and/or power line modems 131) also may include one or more sensors 194 for collecting data, which may be processed, stored and/or transmitted to the power line server 144 or other computer for processing and/or storage.

Accordingly, the power line communication system 102 may provide high speed internet access and streaming audio services to each home, building or other structure, and to each room, office, apartment, or other unit or sub-unit of multi-unit structure using Homeplug®, IEEE 802.11 (Wifi), 802.16, wired Ethernet, or other suitable method.

It is to be understood that the foregoing illustrative embodiments have been provided merely for the purpose of explanation and are in no way to be construed as limiting of the invention. Words used herein are words of description and illustration, rather than words of limitation. In addition, the advantages and objectives described herein may not be realized by each and every embodiment practicing the present invention. Further, although the invention has been described herein with reference to particular structure, materials and/or embodiments, the invention is not intended to be limited to the particulars disclosed herein. Rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention.

What is claimed is:

1. A device for providing communications via an underground power line comprising a plurality of segments disposed in series with each other and carrying power having a voltage greater than one thousand volts on an internal conductor, wherein each segment is coaxial in structure and includes a neutral conductor, comprising:
a first inductor having a first end connected to a first node and a second end connected to ground;
a second inductor having a first end connected a second node and a second end connected to ground;
a transformer having a first winding having a first end and a second end;
wherein said first node is connected to a neutral conductor of a first segment of the power line and to said first end of said first winding of said transformer;
wherein said second node is connected to a neutral conductor of a second segment of the power line and to said second end of said first winding of said transformer; and
wherein said transformer comprises a second winding configured to be communicatively coupled to a communication device.

2. The device according to claim 1, further comprising:
a first voltage clamping device connected in parallel with said first inductor; and
a second voltage clamping device connected in parallel with said second inductor.

3. The device according to claim 1, wherein said first inductor comprises a first air core coil and said second inductor comprises a second air core coil.

4. The device according to claim 1, wherein said first inductor and said second inductor each comprises a coil having a plurality of loops having a substantially rectangular cross section and being separated from each other loop by a dielectric.

5. The device according to claim 1, further comprising:
a first magnetically permeable toroid disposed substantially around the entire circumference of the first segment of the power line; and
a second magnetically permeable toroid disposed substantially around the entire circumference of the second segment of the power line.

6. A method of providing communications via one or more underground power lines, each comprising a plurality of segments disposed in series with each other and carrying power having a voltage greater than one thousand volts on an internal conductor, wherein each segment is coaxial in structure and includes a neutral conductor, comprising:
conducting a first signal along a first communication path from a communication device to a neutral conductor of a first segment;
conducting a second signal along a second communication path from the communication device to a neutral conductor of a second segment; and
wherein the first signal and second signal represent the same data and are substantially the same magnitude and opposite in polarity.

7. The method according to claim 6, further comprising:
providing a first high frequency impedance path between the first communication path and ground; and
providing a second high frequency impedance path between the second communication path and ground.

8. The method according to claim 7, further comprising:
providing a first voltage clamping device disposed in parallel with said first high frequency impedance path; and
providing a second voltage clamping device disposed in parallel with said second high frequency impedance path.

9. The method according to claim 7, wherein the first and second high frequency impedance path each comprises a conductor having a magnetically permeable material disposed substantially around the entire circumference of the conductor.

10. The method according to claim 7, wherein the first and second high frequency impedance path each comprises a coil having a plurality of loops having a substantially rectangular cross section and being separated from each other loop by a dielectric.

11. The method according to claim 6, wherein:
the first signal is conducted from a first end of a first winding of a balun along the first communication path to the neutral conductor of the first segment; and
the second signal is conducted from a second end of the first winding of the balun along the second communication path to the neutral conductor of the second segment.

12. The method according to claim 6, further comprising:
providing a first magnetically permeable toroid substantially around the entire circumference of the first segment; and
providing a second magnetically permeable toroid substantially around the entire circumference of the second segment.

13. A device for providing communications via one or more underground power lines, each comprising a plurality of segments disposed in series with each other and carrying power having a voltage greater than one thousand volts on an internal conductor, wherein each segment is coaxial in structure and includes a neutral conductor, comprising:
a first high frequency impedance having a first end connected to a neutral conductor of a first segment of a power line and a second end connected to ground;
a second high frequency impedance having a first end connected to a neutral conductor of a second segment of the power line and a second end connected to ground; and
a communication device having a first terminal communicatively coupled to said first end of said first high frequency impedance and having a second terminal communicatively coupled to said first end of said second high frequency impedance.

14. The device according to claim 13, wherein said first terminal is communicatively coupled to said first end of said first high frequency impedance via a balun and said second terminal is communicatively coupled to said first end of said second high frequency impedance via said balun.

15. The device according to claim 13, further comprising:
a first magnetically permeable toroid disposed around the circumference of the first segment of the power line; and
a second magnetically permeable toroid disposed around the circumference of the second segment of the power line.

16. The device according to claim 13, further comprising:
a first voltage clamping device disposed in parallel with said first high frequency impedance; and
a second voltage clamping device disposed in parallel with said second high frequency impedance.

17. The device according to claim 13, wherein said first high frequency impedance comprises a first air core coil and said second high frequency impedance comprises a second air core coil.

18. The device according to claim 13, wherein said first high frequency impedance and said second high frequency impedance each comprises a coil having a plurality of loops having a substantially rectangular cross section and being separated from each other loop by a dielectric.

19. A device for providing communications via an underground power line carrying power having a voltage greater than one thousand volts on an internal conductor, the power line being coaxial in structure and having a neutral conductor, comprising:
a high frequency impedance having a first end connected to a first node;
wherein said first node is connected to the neutral conductor of the power line and to a communication device; and
a capacitor having a first terminal connected to the internal conductor of the power line and having a second terminal connected to ground.

20. The device according to claim 19, wherein said high frequency impedance comprises an air core coil.

21. The device according to claim 19, wherein said high frequency impedance comprises a conductor having a magnetically permeable material disposed substantially around the entire circumference of said conductor.

22. The device according to claim 19, wherein said high frequency impedance comprises a coil having a plurality of loops having a substantially rectangular cross section and being separated from each other loop by a dielectric.

23. The device according to claim 19, wherein said capacitor comprises a lightening arrestor.

24. The device according to claim 19, further comprising a voltage clamping device connected in parallel with said high frequency impedance.

25. A device for providing communications via one or more underground power lines, each comprising a plurality of segments disposed in series with each other and carrying power having a voltage greater than one thousand volts on an internal conductor, wherein each segment is coaxial in structure and includes a neutral conductor, comprising:
a first conductor having a first end coupled to a first neutral conductor of a first segment and a second end configured to be connected to a first terminal of a transmitter;
a second conductor having a first end coupled to a second neutral conductor of a second segment and having a second end configured to be connected to a second terminal of the transmitter;
a first impedance forming a conductive path between said first conductor and ground;
a second impedance forming a conductive path between said second conductor and ground; and
wherein the transmitter is configured to differentially apply communication signals to the first and second neutral conductors via said first conductor and said second conductor.
